(19) United States
(12) Patent Application Publication
(10) Pub. No.: US 2013/0095338 A1
(43) Pub. Date: Apr. 18, 2013

(54) Soft Multi-Layer Shrink Films

(71) Applicant: Pang-Chia LU, Pittsford, NY (US)

(72) Inventor: Pang-Chia LU, Pittsford, NY (US)

(21) Appl. No.: 13/603,646

(22) Filed: Sep. 5, 2012

Related U.S. Application Data
(60) Provisional application No. 61/548,389, filed on Oct. 18, 2011.

(51) Int. Cl. B32B 27/08; B29C 47/06

(52) U.S. Cl. 428/519; 264/173.15

(57) ABSTRACT

Disclosed is a multi-layer heat shrink film and a method of making the film comprising a core layer comprising at least one α-olefin copolymer selected from propylene-based elastomers, ethylene plastomers, metallocene catalyzed linear low density polyethylenes, and blends thereof, and an equal or lesser amount of a polypropylene having a melting point higher than α-olefin copolymer; at least one skin layer comprising a cyclic olefin copolymer (COC); and at least one tie layer between at least one skin layer and the core layer, the tie layer comprising a material or blend of soft materials having a Hardness (ISO 7619, Type A) of from 45 to 100; and a Tensile Strength (ISO 37) of from 10 MPa to 30 MPa.

### CROSS-REFERENCE TO RELATED APPLICATION

This application claims the benefit of and priority to U.S. Ser. No. 61/548,389, filed Oct. 18, 2011 which is incorporated by reference.

### FIELD OF INVENTION

The present disclosure relates to multi-layer shrink films comprising at least one core layer comprising an α-olefin copolymer and at least one skin layer comprising a cyclic olefin polymer and at least one tie layer comprising a soft polymer. More specifically, the disclosure relates to multi-layer films useful as solvent sealable shrink labels.

### BACKGROUND OF THE INVENTION

Shrink labels represent a high proportion of labeling applications. High shrink labels are the fastest growing segment in the labeling business due to the trend toward using contoured containers and shrink sleeve labels with 360° graphics for high customer appeal. Application of heat to a shrink label around a contour container causes the label to shrink preferentially in the direction extending circumferentially around the container to conform to the outside container shape.

Shrink labels fall into two categories: roll-on-shrink-on (ROSO) labels and sleeve labels. ROSO labels are supplied from a reel, cut into sheets, applied around a container, and seamed around the container during the labeling step using hot melt to form a seam, with the machine direction (MD) of the film extending circumferentially around the container. ROSO label films primarily shrink in the MD direction and generally employ biaxially oriented polypropylene (BOPP) films.

In contrast, sleeve labels are solvent seamed into a tube and supplied from that tube placed around a container, with the transverse direction (TD) of the film extending circumferentially around the container. Application of heat causes the label to shrink, preferably in the direction extending circumferentially around the container and to conform to the container. Sleeve labels primarily shrink in the TD direction.

While ROSO labels offer a cost advantage, the sleeve labels enjoy an advantage in the extent of shrink percentage that can be obtained. Sleeve labels typically shrink up to 60% to 70% around the circumference of the container whereas commercial ROSO films shrink only up to 20%.

Currently, no “all polyolefin” shrink films are known to be solvent seamed to form a tube, due to the inability of solvent to swell semi-crystalline materials. Solvent sealable material like polystyrene (PS) or polyethylene terephthalate (PET) may be coextruded on the polyolefin based film, but it will require an expensive tie layer to bond the solvent sealable skin on the polyolefin core layer. Such combination of a solvent sealable skin on a polyolefin core layer using an adhesive tie layer has other disadvantages like the development of haze on film after shrinkage or poor optics when the film is recycled.

It is therefore desirable to obtain a polyolefin based film suitable for sleeve labeling that can be seamed on the current available solvent seamed machines and shrunk around a container to at least 30%, has low natural shrinkage, and can be easily separated from PET flakes for recycling. Shrinkage in a steam tunnel for high heat efficiency would be preferred.

It was disclosed in WO 2010/047906 that combining a polyolefin core layer with one or two skin layers composed of solvent sealable or swellable polymer such as COC provides a film that can be used for shrink sleeve labeling. One potential problem, in some applications, with these films is that the COC skins are so hard that they may essentially “shatter” and cause failure in the seal of the film to itself or another film. What is needed is a means of controlling such failure while maintaining or strengthening the seal in such films, and at a reasonable cost.

Other disclosures include U.S. Pat. Nos. 7,052,750; 6,894,696; U.S. Patent Application Publication Nos. 20011/0212338; 2009/0291284; 2009/0220757; 2009/0197022; 2009/0136698; 2009/0105418; 2008/0248229; 2007/0251572; 2006/0178483; 2005/0214557; 2003/0143357; WO 2006/071826 and 2005/097493; and EP 1 423 408; EP 1 632 343; and EP 1 300 238.

### SUMMARY OF THE INVENTION

Accordingly, in one aspect described herein, is a multi-layer heat shrink film, preferably mostly (or only) shrinkable in the TD, comprising a core layer including at least one α-olefin copolymer selected from propylene-based elastomers, ethylene plastomers, metallocene catalyzed linear low density polyethylenes, and blends thereof, and from 5 wt % to 50 wt % of a polypropylene having a melting point higher than α-olefin copolymer; at least one skin layer comprising a COC; and at least one tie layer between the at least one skin layer and the core layer, the tie layer comprising a relatively soft material or blend of soft materials having, for example, a Hardness (ISO 7619, Type A) of from 45 to 100; a Tensile Strength (ISO 37) of from 10 MPa to 30 MPa; and, in particular embodiments, an Elongation (ISO 37) of from 400% to 900%. In a particular embodiment, the tie layer comprises a styrenic block copolymer.

In another aspect is a method of forming a TD shrink label comprising coextruding at least three, four, or five layers of materials, each layer comprising the components described above, followed by forming an at least three, four, or five layer film therefrom; stretching the film in the machine direction (MD) at a temperature that is within a range of from 4° C. below the T_{g} of the COC in the skin layer(s) to a temperature greater than or equal to the T_{g} of the COC in the skin layer(s) at a stretching ratio within the range of from 1.05 to 2.8, at a stretching time within the range of from 1 to 10 seconds; and stretching then in the transverse direction (TD) at a temperature within the range of from 70° C. to 120° C. at a stretching ratio within the range of from 4 to 10.

### DETAILED DESCRIPTION

The inventor has discovered flexible, multi-layered transverse direction (TD) oriented films that are solvent sealable, mostly polyolefin (thus, low density and more easily recyclable) and have improved impact resistance while maintaining seal strength. Disclosed are 3 (A/B/C), 4 (A/B/C/A′), 5 (A/B/C/B′/A′), or more layer films comprising at least one core layer having a first and second side and (when at least 5 layers) sandwiched between a tie layer and skin layer on each side, the tie layers contacting at least the first side, forming an A/B/C or an A/B/C/A′ or an A/B/C/B′/A′ structure, where each of A and A′ and B and B′ can be the same or different. The core layer primarily comprises an α-olefin copolymer and from 5 wt % to 50 wt % of a higher melting point polypropylene; and the skin(s) comprises a cyclic-olefin copolymer (“COC”), with at least one tie layer comprising a soft polymer. Thus, in one embodiment, the core layer comprises from 5 wt % to 50 wt % of a polypropylene (ASTM D3418 melting point of 125° C. or more) and an α-olefin copolymer having a melting point lower than that of the polypropylene, and at least one skin layer and at least one tie layer there between the skin and core layers.

Core Layer Polypropylene. The “polypropylene” that is preferably used in the core layer is a homopolymer or copolymer comprising from 60 wt % or 70 wt % or 80 wt % or 85 wt % or 90 wt % or 95 wt % to 100 wt % propylene-derived units (and comprising within the range of from 0 wt % or 1 wt % or 5 wt % to 10 wt % or 15 wt % or 20 wt % or 30 wt % or 40 wt % C₂ and/or C₄ to C₁₀ α-olefin derived units) and can be made by any desirable process using any desirable catalyst as is known in the art, such as a Ziegler-Natta catalyst, a metallocene catalyst, or other single-site catalyst, using solution, slurry, high pressure, or gas phase processes. Polypropylene copolymers are useful polymers in certain embodiments, especially copolymers of propylene with ethylene and/or butene, and comprise propylene-derived units within the range of from 70 wt % or 80 wt % to 95 wt % or 98 wt % by weight of the polypropylene. In any case, useful polypropylenes have a melting point of at least 125° C. or 130° C. or 140° C. or 150° C. or 160° C., or within a range of from 125° C. or 130° C. to 140° C. or 150° C. or 160° C. A “highly crystalline” polypropylene is useful in certain embodiments, and is typically isotactic and comprises 100 wt % propylene-derived units (propylene homopolymer) and has a relatively high melting point of from greater than (greater than or equal to) 140° C. or 145° C. or 150° C. or 155° C. or 160° C. or 165° C.

The term “crystalline,” as used herein, characterizes those polymers which possess high degrees of inter- and intra-molecular order. In certain embodiments the polypropylene has a heat of fusion (H_{f}) greater than 60 J/g or 70 J/g or 80 J/g, as determined by DSC analysis. The heat of fusion is dependent on the composition of the polypropylene; the thermal energy for the highest order of polypropylene is estimated at 189 J/g that is, 100% crystallinity is equal to a heat of fusion of 189 J/g. A polypropylene homopolymer will have a higher heat of fusion than a copolymer or blend of homopolymer and copolymer. Also, the polypropylenes useful herein may have a glass transition temperature (ISO 11357-1, T_{g}) in certain embodiments between −20° C. or −10° C. or 0° C. to 10° C. or 20° C. or 40° C. or 50° C.

In certain embodiments, the polypropylene has a melt flow rate (“MFR”, 230° C., 2.16 kg, ASTM D1238) within the range of from 0.1 g/10 min or 0.5 g/10 min or 1 g/10 min to 4 g/10 min or 6 g/10 min or 8 g/10 min or 10 g/10 min or 12 g/10 min or 16 g/10 min or 20 g/10 min. Also, the polypropylene may have a molecular weight distribution (determined by GPC) of from 1.5 or 2.0 or 2.5 to 3.0 or 3.5 or 4.0 or 5.0 or 6.0 or 8.0 in certain embodiments. Suitable grades of polypropylene that are useful in the oriented films described herein include those made by ExxonMobil, LyondellBasell, Total, Borealis, Japan Polypropylene, Mitsui, and other sources.

Core Layer α-olefin Copolymers. As described above, the core layer comprises one or more α-olefin copolymer modifiers. The α-olefin copolymers used for the core layer preferably have melting points of less than 125° C. or 120° C. or 110° C. or 105° C.; and in other embodiments in the range of from 60° C. to less than 125° C., more preferably from 60° C. to 100° C. Propylene and ethylene homopolymers and copolymers and combinations thereof are usually used for forming the core layer of the films according to the disclosure. Core layers may include propylene-based elastomers, ethylene based plastomers, metallocene catalyzed linear low density polyethylenes, as defined hereafter, and combinations thereof. Propylene-based elastomers are most desirable.

In any of the described variations herein, the core layer can consist essentially of one polypropylene and one α-olefin copolymers, and, in very particular embodiments, can consist of these components. By “consisting essentially of,” what is meant is that the core can also include other minor components, such as anti-slip agents, anti-oxidant agents, anti-blocking agents, fillers and cavitation agents, and other common minor components as long as they do not change the claimed properties of the composition or film by any more than 1% or 2% or 3%. Also, when referring to the composition “comprising polypropylene,” or other component, it is understood that this includes a mixture of the named component having the claimed features.

The “propylene-based elastomers” are polymers comprising from 94 wt % to 75 wt % propylene-derived units and have a melting point below the propylene copolymers described herein. Propylene-based elastomers typically have a heat of fusion (H_{f}) less than or equal to 75 J/g or 60 J/g or 50 J/g and a triad tacticity of three propylene units, as measured by ¹³C NMR, of 75% or greater, or even 90% or greater. The lowered H_{f} may result from stereo or regio errors and/or from the random incorporation of one or more units derived from an α-olefin comonomer of a C₂ or C₄-C₁₀ α-olefin and optionally diene-derived units. Such propylene-based elastomers can comprise within the range of from 6 wt % to 12 wt % or 16 wt % or 20 wt % or 25 wt % α-olefin, and more preferably more than 7 wt % α-olefin. Propylene-based elastomers comprising from 8 wt % to 12 wt % ethylene are particularly suitable.

In particular embodiments, the propylene-based elastomers have a single peak melting transition as determined by DSC; in certain embodiments, the propylene-α-olefin elastomer has a primary peak melting transition at from less than 90° C., with a broad end-of-melt transition at greater than about 110° C. The peak “melting point” (Tₘ) is defined as the temperature of the greatest heat absorption within the range of melting of the sample. However, the propylene-based elastomer may show secondary melting peaks adjacent to the principal peak, and/or the end-of-melt transition, but for purposes herein, such secondary melting peaks are considered together as a single melting point, with the highest of these peaks being considered the peak melting temperature (Tₘ), or “melting point,” of the propylene-based elastomer. In very particular embodiments, the propylene-based elastomers have a Tₘ from less than 70° C. or 80° C. or 90° C. or 100° C. or 105° C. in certain embodiments; and within the range of from 10° C. or 15° C. or 20° C. or 25° C. to 65° C. or 75° C. or 80° C. or 95° C. or 105° C. in other another embodiments.

Triad tacticity is determined according to the method as disclosed in U.S. Patent Application Publication No. 2004/0236042. The propylene-based elastomers may have an H_{f} which is greater than or equal to 0.5 J/g and preferably less than or equal to about 50 J/g. The H_{f} is determined using ASTM E-794-95 (version E-794-01). Preferred propylene-based elastomers have a Mooney viscosity [ML (1+4) @ 125° C.], determined according to ASTM D1646, of less than 100, preferably less than 60, or less than 30 MU. The molecular weight distribution index (Mw/Mn) of the propylene-alpha olefin elastomers may be from 1.8 to 3 or 3.5 or 4 as determined by Gel Permeation Chromatography (GPC). Preferred propylene-based elastomers are available commercially under the trade names Vistamaxx™ (ExxonMobil Chemical Company, Houston, Tex., USA) and Versify™ (The Dow Chemical Company, Midland, Mich., USA), certain grades of Tafmer™ XM or Notio™ (Mitsui Company, Japan) and certain grades of Softel™ (LyondellBasell Polyolefins of the Netherlands).

In any case, the core layer of the films described herein may comprise within the range of from 5 wt % or 10 wt % or 15 wt % to 25 wt % or 35 wt % or 45 wt % or 50 wt % of the polypropylene and within the range of from 50 wt % or 60 wt % or 70 wt % to 80 wt % or 85 wt % or 90 wt % or 95 wt % of one or more propylene-based elastomers, by weight of all the core layer materials. These same weight percentages also apply to the other α-olefin copolymers described below.

Ethylene-based plastomers are very low density linear polyethylenes (VLDPE) having a density between 0.85 g/cm³ to 0.91 g/cm³ determined according to ASTM D1505. Ethylene-based plastomers contain a sufficient quantity of units derived from a C₃ to C₁₀ comonomer, preferably C₄ to C₈ α-olefins to, among other things, achieve required density. Ethylene-based plastomers are preferably produced in solution or under high pressure conditions using single site catalysts such as biscyclopentadienyl or monocyclopentadienyl metallocenes. In certain embodiments, ethylene-based plastomers useful herein have a melting point of less than 100° C. or 90° C. or 80° C. or 75° C., and in other embodiments, within the range of from 60° C. or 65° C. to 75° C. or 80° C. or 90° C. or 100° C. Such plastomers are commercialized by ExxonMobil under the trade name of Exact™, by Dow under the trade name of Affinity™, and by Mitsui under the trade name of Tafmer™.

With regard to LLDPE, metallocene linear low density polyethylenes (LLDPE's) have a density of from 0.910 g/cm³ to 0.940 g/cm³ determined according to ASTM D1505. They may be produced in solution, slurry, or gas phase conditions using a single site catalyst, such as a metallocene activated by methods well known for such components, for example, with aluminoxane or a non-coordinating anion. Low melt index ratio linear polyethylene polymer is a linear polyethylene with a shear sensitivity expressed as melt index ratio I_{21.6}/I_{2.16} ratio (MIR) of less than 30 as determined by ASTM 1238 (2.16 kg and 21.6 kg at 190° C.). The low MIR indicates no or a low level of long chain branches as well as a narrow molecular weight distribution. High MIR linear polyethylenes include LLDPE's with an MIR of more than 30 which in combination with a relatively low Mw/Mn value is generally accepted to be indicative of the presence of long chain branching. These polymers may be referred to as “homogeneously branched linear polyethylenes.” The branches are believed to be linear in structure and may be present at a level where no peaks can be specifically attributed to such long chain branches in the ¹³C NMR spectrum. Preferable LLDPE's have a melting point of less than 125° C. or 120° C. or 110° C. or 100° C.

Metallocene LLDPE's are commercialized by ExxonMobil Chemical Company under the trade name of Exceed™ and Enable™ and by Dow Chemical Company under the trade name of Elite™.

In some embodiments, the core layer consists essentially of one α-olefin copolymer. In other embodiments, the core layer comprises (or consists essentially of) polymer blend(s) of an α-olefin copolymer with other polymers, preferably with different α-olefin copolymer(s).

Polymer blends containing from 50 wt % to 95 wt % of at least one polymer selected from propylene-based elastomers, ethylene plastomers, metallocene catalyzed linear low density polyethylenes or blends thereof, and from 5 wt % to 50 wt % of at least one polypropylene having a higher melting point, and, preferably, a higher H_{f} and/or crystallinity, generally provide films that can be easily oriented on a tenter frame with uniform film flatness and web integrity.

Certain blends of α-olefin copolymers may be desirable. In one embodiment, the core layer contains from 5 wt % to 20 wt % of low density polyethylene (LDPE). LDPE have a density range of 0.910 g/cm³ to 0.940 g/cm³ and are produced using a high pressure process via free radical polymerization. Another embodiment uses polymer blends containing from 5 wt % to 20 wt % of ethylene based plastomer and/or from 5 wt % to 20 wt % of metallocene linear low density polyethylene.

The core layer may also contain COC as defined below. Films comprising a core layer having up to 30 wt % of COC have improved stiffness. The core layer usually contains less than 20 wt %, preferably from 5 wt % to 10 wt %, COC based on the weight percent of the polymers present in the core layer. In some embodiments, the COC in the core layer may come from the recycling of the edge trims or reclaimed film.

It is contemplated that the core layer may comprise minor amounts (less than 10 wt % or 5 wt % by weight of the core layer) of other polymer(s), such as PETG, PET, polylactic acid, PVC, polystyrene, styrenic block copolymers, or combination thereof. However, these polymers are usually excluded from the core layer of the films according to the disclosure.

The core layer may contain other additives, such as inorganic fillers, pigments, antioxidants, acid scavengers, ultraviolet absorbers, processing aids, such as zinc stearate, extrusion aids, slip additives, permeability modifiers, antistatic additives, cavitating agents, such as calcium carbonate, and β-nucleating agents. These additives may be introduced into the core layer in the form of master batch in a polyolefin, typically in LDPE.

The core layer will preferably comprise from 50 wt % to 98 wt %, more preferably from 60 wt % to 95 wt %, still more preferably from 70 wt % to 90 wt %, and even more preferably from 80 wt % to 95 wt % of the weight of the multi-layer films of the present disclosure. For economical reasons, the core layer usually comprises from 70 wt % to 85 wt % of the multi-layer films of the present invention.

Skin Layers. The multi-layer film of the present disclosure also comprises at least one skin layer comprising preferably at least one cyclic olefin copolymer (COC). Preferably, the film comprises 2 skin layers, each comprising at least one COC.

The COC used in the present disclosure are random copolymers of ethylene or propylene and a cyclic olefin, such as, norbornene and/or its derivatives and tetracyclododecene and/or its derivatives. The glass transition temperature (T_{g}) of the COC used according to the present disclosure is usually from 35° C. or 45° C. or 60° C. to 120° C., more preferably 70° C. to 80° C. to achieve low natural shrinkage. COC with lower glass transition temperature, for example, with a glass transition temperature as low as 35° C. or 45° C. or 50° C., may be used for films which shrink at very low temperature but those films could have higher natural shrinkage and could require transportation and/or storage under controlled conditions. The material's volume flow rate (MVR) measured at 260° C. under 2.16 kg according to ISO 113 is preferably between 1 ml/10 min and 60 ml/10 min, preferably between 20 ml/10 min and 50 ml/10 min. The density of the COC, according to ISO 1183, is preferably in the range of from 1.00 to 1.06 g/cm³. The number average molecular weight measured by GPC is typically from 1,000 to 1,000,000. COC useful, according to the present disclosure, include Topas™ products available from Ticona and Zeonor™ products available from Zeon Chemicals.

In an embodiment, the skin layer comprises at least 55 wt %, preferably at least 70 wt %, and most preferably at least 90 wt % of COC of the polymers present in the skin layer. In certain embodiments, one or more skin layers consist essentially of (may include minor amount of additives) one or more COC's; and in a particular embodiment, one or more skin layers may consist of one or more COC's. In addition to the COC, the skin layer(s) may also contain other film forming polymer resin(s) in a lesser amount, generally less than 45 wt % or 30 wt % or 10 wt %. Such polymeric resin(s) include propylene and ethylene homopolymers and copolymers and any combination thereof.

The use in the COC skin layer of polymer(s) with melting point lower than, or equal to, the stretching temperature of the α-olefin copolymer in the core layer, such as, for example, the Exceed metallocene LLDPE or the Exact ethylene based plastomer, is preferred for the preparation of transparent films. The addition of material with higher melting point may be used when transparency is not an issue.

The skin layer(s) may also advantageously contain other additives, such as pigment, antioxidants, acid scavengers, ultraviolet absorbers, processing aids, such as zinc stearate, extrusion aids, antiblock, slip additives, or antistatic additives.

The skin layers may comprise from 10 wt % to 80 wt %, preferably from 10 wt % to 70 wt % and more preferably from 15 wt % to 50 wt % and even more preferably from 30 wt % to 50 wt % of the multi-layer films of the present disclosure. For economical reasons, the skin layer usually comprises from 30 wt % to 15 wt % of the multi-layer films of the present invention.

In embodiments with two or more skin layers, the skin layers may be made of different polymer(s) or of the same polymer(s) in different or in the same ratio. More preferably, the films according to the present embodiment have two skin layers of the same polymer configurations and polymer composition ratios.

Tie Layers. The multi-layer films described herein comprise one or more tie layers. Tie layers can be beneficial in helping to ensure good adhesion between the skin layers and the core layer, and to modify the impact properties of the film. The tie layer will preferably comprise from 5 wt % to 15 wt % of the entire multi-layer film. In certain embodiments, the tie layer(s) are the same or different and comprise a material or blend of materials having a Shore A Hardness (ISO 7619 or ASTM D2240) of from 45 or 50 or 55 or 60 to 90 or 95 or 100; a Tensile Strength (ISO 37 or ASTM D412) of from 10 MPa or 15 MPa or 17 MPa or 19 MPa to 23 MPa or 25 MPa or 27 MPa or 30 MPa; and in a particular embodiment, an Elongation (ISO 37) of from 400% or 450% or 500% to 750% or 800% or 850% or 900%. The tie layer materials may be any desirable soft and/or elastomeric polymer, such as the propylene-based elastomer or ethylene elastomer described above, and/or a styrenic block copolymer, or any other polymer useful for modifying the impact properties of polymer compositions that meet one or more of the Hardness, Tensile Strength, or Elongation properties above. In such instances, the material or blend of materials in the tie layer may comprise from 50 wt % or 60 wt % to 70 wt % or 80 wt % or 90 wt % or 95 wt % to 99 wt %, by weight of the tie layer, of the soft material(s).

In a particular embodiment, the tie layer(s) comprises (or consists essentially of) a styrenic block copolymer. Desirable polymers will have a density within the range of from 0.850 g/cm³ or 0.860 g/cm³ or 0.870 g/cm³ to 0.930 g/cm³ or 0.940 g/cm³ or 0.960 g/cm³ or 1.000 g/cm³ or 1.050 g/cm³ (ISO 1183). Preferably, the styrenic block copolymers comprise from 15 wt % or 20 wt % or 25 wt % to 35 wt % or 40 wt % or 45 wt % or 50 wt % styrenic derived units, by weight of the copolymer. Preferably, the styrenic block copolymer is a styrene-ethylene/butylene-styrene terpolymer having a melt flow rate (MFR, ASTM D 1238, 230° C. at 2.16 kg) of from 0.5 g/10 min or 1 g/10 min or 2 g/10 min or 3 g/10 min to 6 g/10 min or 8 g/10 min or 10 g/10 min or 12 g/10 min. Desirable styrenic block copolymers may be SEBS or SBBS Tuftec™ styrenic elastomers from Asahi Kasei Chemicals; Chevron Phillips K-Resins™; and Kraton™ D or G Elastomers.

The styrenic block copolymer may comprise from 50 wt % or 60 wt % or 70 wt % to 90 wt % or 100 wt %, by weight of the tie layer materials, of the tie layer. The tie layer may consist essentially of, or consist of, the styrenic block copolymer, but when other materials are present, skin layer materials or core layer materials may make up a portion or all of the remainder. In one embodiment, the tie layer(s) is made from a blend of the styrenic block copolymer and the COC, the latter being present in the tie layer within a range of from 5 wt % or 10 wt % or 20 wt % to 40 wt % or 50 wt %, by weight of the tie layer.

Films and Method of Making Films. The films described herein typically have a thickness of from 20 μm to 300 μm, preferably from 30 μm to 150 μm. Films having a thickness of from 40 μm to 90 μm are particularly suitable according to the present disclosure.

The films of the present disclosure can be produced by any known method. The films may be obtained by extrusion or coextrusion through cast die or annular die. The multi-layered films described herein can be cast at line speeds of from 20 fps or 30 fps to 50 fps or 60 fps or 80 fps in certain embodiments, but line speeds can be much higher, such as up to 400 fpm or 500 fpm or 600 fpm, depending on the polymer output rate. In certain embodiments, the casting temperature is within the range of from 30° C. or 32° C. to 40° C. or 50° C. or 60° C. The films may be oriented in both the TD and MD to some degree, but preferably, mostly (or only), in the TD.

More particularly, the films can be made by any suitable technique known in the art, such as a tentered or blown process, LISIM™, and others. Further, the working conditions, temperature settings, lines speeds, etc., will vary depending on the type and the size of the equipment used. Nonetheless, described generally here is one method of making the films described throughout this specification. In a particular embodiment, the films are formed and biaxially oriented using the “tentered” method. In the tentered process, line speeds of greater than 100 m/min to 400 m/min or more, and outputs of greater than 2000 kg/hr to 4000 kg/hr or more, are achievable. In the tenter process, sheets/films of the various materials are melt blended and coextruded, such as through a 3, 4, 5, 7-layer die head, into the desired film structure. Extruders ranging in diameters from 100 mm to 300 mm or 400 mm, and length to diameter ratios ranging from 10/1 to 50/1 can be used to melt blend the molten layer materials, the melt streams then metered to the die having a die gap(s) within the range of from 0.5 or 1 to an upper limit of 3 mm or 4 mm or 5 mm or 6 mm. The extruded film is then cooled using air, water, or both. Typically, a single, large diameter roll partially submerged in a water bath, or two large chill rolls set at 20° C. or 30° C. to 40° C. or 50° C. or 60° C. or 70° C., are suitable cooling means. As the film is extruded, an air knife and edge pinning are used to provide intimate contact between the melt and chill roll.

Downstream of the first cooling step in this embodiment of the tentered process, the unoriented film is reheated to a temperature of from 80° C. to 100° C. or 120° C. or 150° C., in one embodiment by any suitable means, such as heated S-wrap rolls, and then passed between closely spaced differential speed rolls to achieve machine direction orientation. It is understood by those skilled in the art that this temperature range can vary depending upon the equipment, and, in particular, upon the identity and composition of the components making up the film. Ideally, the temperature will be below that which will melt the film, or cause it to become tacky and adhere to the equipment, but high enough to facilitate the machine direction orientation process. Such temperatures referred to herein refer to the film temperature itself. The film temperature can be measured by using, for example, infrared detection means, the source aimed at the film as it is being processed; those skilled in the art will understand that for transparent films, measuring the actual film temperature will not be as precise. In this case, those skilled in the art can estimate the temperature of the film by knowing the temperature of the air or roller immediately adjacent to the film measured by any suitable means. The heating means for the film line may be set at any appropriate level of heating, depending upon the instrument, to achieve the stated film temperatures.

The lengthened and thinned film is cooled and passed to the tenter section of the line for TD orientation. At this point, the edges of the sheet are grasped by mechanical clips on continuous chains and pulled into a long, precisely controlled hot air oven for a pre-heating step. The film temperatures range from 70° C. or 80° C. or 90° C. or 100° C. or 110° C. to 150° C. or 170° C. or 180° C. in the pre-heating step. Again, the temperature will be below that which will melt the film, or cause it to become tacky and adhere to the equipment, but high enough to facilitate the step of transverse direction orientation. Next, the edges of the sheet are grasped by mechanical clips on continuous chains and pulled into a long, precisely controlled hot air oven for transverse stretching. As the tenter chains diverge a desired amount to stretch the film in the transverse direction, the film temperature is lowered by at least 2° C., but typically no more than 20° C., relative to the pre-heat temperature to maintain the film temperature so that it will not melt the film. After stretching to achieve transverse orientation in the film, the film is then cooled from 5° C. to 10° C. or 15° C. or 20° C. or 30° C. or 40° C. below the stretching temperature, and the clips are released prior to edge trim, optional coronal, printing, and/or other treatment can then take place, followed by winding.

In a preferred embodiment, the films are preferentially oriented at least in the TD. The following method may be used. Using a plurality of extruders, the resins are melted, coextruded from the T-die, solidified by cooling with a chilled roll, roll stretched in the MD, if needed, tenter-stretched in the TD, heat set, cooled, optionally subjected to corona discharge treatment at least on one surface, and wound up with a winder, thus, obtaining a film. While stretching in the MD does not seem essential according to that embodiment, some stretching in the MD direction is desirable to improve the easiness of splitting the film in the lateral direction. As the conditions for the MD stretching, the following ranges are preferable. The temperature is from 70° C. to 90° C., the stretching ratio is from 1.05 to 2.8, preferably 1.2 to 2.5, and the stretching time is from 1 to 10 seconds, preferably as short as possible, such as below 0.3 second.

The MDO (machine direction orientation) temperature in a particular embodiment is set at a temperature equal to or greater than the T_{g} of the COC in the skin layer(s); in other embodiments, depending on the line speed, the temperature may go somewhat (1° C. to 4° C.) below the T_{g} of the COC containing skin. For example, at a line speed at 128 fpm, the MDO temperature may be set at 81° C. to 83° C. when using Topas 8007-F04, having a T_{g} of 78° C. At 100 fps line speed, the MDO temperature may be set at from 75° C. to 80° C. using the same COC. Line speeds may be much higher, such as a speed of from 400 fpm to 500 fpm or 600 fpm. Typically, the COC skin layers cannot be stretched well below the T_{g} temperature, such as 2° C. or 3° C. or 4° C. below the T_{g}. The MDO temperature setting may also be line speed related—the residence time for MDO to get sufficient heat so that it is soft enough to be stretched. Desirably, however, the MDO temperature is not greater than 85° C. or 87° C. or 90° C. or 95° C.; or in another embodiment, the MDO temperature is not more than 5° C. or 10° C. or 15° C. above the T_{g} of the COC used in the skin(s). Thus, in certain embodiments, the MDO is at a temperature that is within a range of from 4° C. below the T_{g} of the COC in the skin layer(s) to a temperature greater than or equal to the T_{g} of the COC in the skin layer(s), preferably, no more than 5° C. or 10° C. or 15° C. above the T_{g} temperature. In a particular embodiment, the MDO temperature is set at a temperature within the range of from 70° C. or 72° C. or 74° C. to 90° C.

The conditions for the TD stretching are preferably as follows: the temperature is in the range of from 70° C. or 75° C. or 80° C. to 100° C. or 110° C. or 120° C., and the stretching ratio is from 4 or 5 to 9 or 10. The TDO (transverse direction orientation) will depend on the line speed and the T_{g} of the COC in the skin layer(s), and is preferably controlled as in the MDO. Thus, in certain embodiments, the TDO is at a temperature that is within a range of from 4° C. below the T_{g} of the COC in the skin layer(s) to a temperature greater than or equal to the T_{g} of the COC in the skin layer(s), preferably, no more than 5° C. or 10° C. or 15° C. above the T_{g} temperature.

In certain embodiments, the MDO and/or the TDO temperature is at least as high as the T_{g} of the polymeric component in the whole multi-layered film (any of the layers) with the highest T_{g}, but preferably no more than 5° C. or 10° C. or 15° C. above the T_{g} of the polymer with the highest T_{g} temperature, and no more than 5° C. below the polymer with the highest T_{g} in a particular embodiment.

As mentioned, films according to the disclosure may also be taken through secondary processes. This includes, corona and/or flame plasma treatments, metallization through vacuum metallization, printable topcoat applied as needed to enhance the decorative nature of the film; lamination or protecting coating, such as lacquers may also be applied. Finally, the films may be printed upon with words and/or decorations to form labels.

In a preferred embodiment, the multi-layer film of the present disclosure consists of a three, four, or five layer film essentially mono-oriented in the transverse direction and comprising a core layer comprising at least 50 wt % of a at least one α-olefin copolymer selected from propylene-based elastomers, ethylene plastomers, and metallocene catalyzed linear low density polyethylene, or preferably a blend of propylene-based elastomer and copolymer of propylene ethylene and, optionally, butene as described above, two tie layers as described above adjacent to the core layer, and two skin layers comprising at least 90 wt % of a COC having a T_{g} of from 70° C. to 80° C.

The multi-layer heat shrink films of the present disclosure usually have a shrinkage of 10% or 30% or more, preferably 40% or more, more preferably 50% or more in the TD when placed during 7 minutes in an oven at temperature of from 60° C. to 150° C., typically from 70° C. to 135° C. or during 10 seconds in water bath at temperature of from 60° C. to 100° C. On the other hand, the multi-layer films described herein may have no MD shrinkage in certain embodiments, or have an MD expansion of from less than 5%, or within a range of from 1% to 5% or 10% or 15% when heated. Shrinkage is determined by measuring the difference of sample length before and after placing the sample, unrestrained, in an oven or in a water bath at the selected temperature (ASTM 1204).

Clarity (especially contact clarity) and transparency are desirable in applications where a non-obscure view of the product around which the films (or, as printed upon, labels) resides. High clarity and transparency are also desirable for “reverse” printing of labels, where printing resides between the labels and the container and a consumer views the printing through the label. Thus, low “haze” is desirable.

Haze values of the films according to the disclosure may range depending on the application. When the application requires high clarity and low haze, the haze value, determined according to ASTM method D-1003, is 20% or less, preferably less than 15%, more preferably 10% or less, and less than 5% in a particular embodiment. Low haze values are desirably obtained with films whose skin layers are comprised of polymer(s) with melting point lower than, or equal to, the stretching temperature.

The films according to the disclosure are useful as shrinkable labels and packaging (“labels”) for many shrink film applications for packaging articles including without limitations, batteries, aluminum can containers, aerosol cans, plastic liquid beverage containers, glass containers, and irregular shaped containers. The films, thus, can serve the dual purpose of providing information to a customer about the product and wrapping and containing the article therein.

The films of the present disclosure further have a particular utility as labels such as sleeve labels. To convert a film of the present disclosure into a sleeve label, the stretched film is usually subjected to printing by a suitable method such as gravure or offset printing on the surface subjected to corona discharge treatment. To obtain a tubular label from the printed planar heat shrinkable film thus prepared, centre sealing is carried out with the use of an organic solvent as described, for example, in EP 1 632 343 and cut into appropriate lengths thereby obtaining labels as sleeve form. The organic solvent is not particularly limited insofar as it dissolves or swells the front back film layers of the film. Organic solvents comprising tetrahydrofuran (THF), cyclohexane, or methyl ethyl ketone (MEK) are preferred and, more preferably, blends of these solvents.

Films and labels of the present disclosure can also advantageously possess perforations through the film or label. Perforations are most desirably carried out immediately before the sealing.

The benefits of the presence of COC in the skin layers enable the solvent seaming of the films. The films, according to the disclosure, have improved stiffness.

The following examples serve as an illustration of the disclosure, the measured features and the units for their expressions are explained hereafter.

### EXAMPLES

Multi-layer cast films were prepared using multi-layer cast film line under conditions commonly known in the art. The target gauge for the films was 2.0 mil (50 μm). The MDO was a ratio of 1.5 and the temperature at 82° C. with line speed at 128 fpm; or for a different line, the MDO temperature was set at 75° C. to 80° C. with line speed at 100 fpm, and the TDO was a ratio of 8. The casting temperature started at about 38° C. and the maximum cast roll speed was about 50 fpm and the line speed of 75 fpm. Each coextruded film had an A/C/A or A/B/C/B/A structure where the “A” layers are the skin layers comprising the COC, the “C” layer is the core layer, and the “B” layers are the tie layers.

The composition of the layers and properties of the oriented films are given in Table 1 below, wherein:

Topas Skin Layer: COC commercialized by Topas. Topas 8007 has a glass transition temperature of 78° C. (ISO 11357-1, -2, -3);
Vistamaxx Core: propylene-based elastomer, ExxonMobil, Vistamaxx 3980 (“VMX”) has a peak melting point at 77° C.;
Tuftec H1041 Tie Layer: styrene-ethylene/butylene-styrene terpolymer having a Hardness (Type A) of 84, Tensile Strength of 21.6 MPa, and Elongation of 650%;
8573 Core: Total 8573 high ethylene copolymer, MFR (230° C., 2.16 kg) of 7 g/10 min, MP of 135° C.;

DK11 Skin Layer: Chevron Phillips K Resin DK11 (styrene butadiene), MFR (230° C., 2.16 kg) 7.50 g/10 min; film MD tensile strength at yield of 26 MPa;

KR52 Skin Layer: Chevron Phillips K Resin KR52 (styrene butadiene), MFR (230° C., 2.16 kg) 9 g/10 min;
EA3400 Skin Layer: Chevron Phillips EA3400, MFR (230° C., 2.16 kg) 9 g/10 min polystyrene;
G1645 Tie Layer: Kraton G1645 (styrene-ethylene/butene-styrene), MFR (230° C., 2.16 kg) 2-4.5 g/10 min, 11.5% to 13.5% styrene content, Hardness (Type A) of 35, Tensile Strength of 10.4 MPa;
AMF-702: Skin Layer additive: A fluoropolymer masterbatch from A. Schulman Americas Company, a processing aid;
Be-sq195: Skin Layer additive: Microcrystalline wax from Baker Petrolite; and
HIPS-740: Skin Layer: Total polystyrene, MFR (200° C., 5 kg) of 4 g/10 min, flexural modulus of 2550 MPa.

All samples were 3-or 5-layer 2 mil coextruded films with 80/20 Vistamaxx 3980/8573 ethylene-propylene copolymer blend in the core layer. Samples were solvent sealed with tetrahydrofuran (THF), seal width ⅜ inch or ¼ inch, standard 12 inch/min peel. If a 3-layer film, the skin was maintained at 10% on each side; if 5-layer, each skin and tie layer was 5% on each side of the film. The solvent sealability of TD shrink samples was tested. The film sample was wiped with THF using cotton swab on one side of skin. Sample films were sealed with THF with the seal width of ⅜ inch or ¼ inch as stated in Table 1. The wider the sealed area, the higher the peel force. The film was folded over to form a fin seal with finger pressure. After drying at room condition for 24 hours, the seals were cut to 1 inch width and tested for 180° T-peel on an Instron tester. The standard peel speed is 12 inch/min.

The MD/TD shrinkage of all sample films was measured and also shown in Table 1. Percent shrink was measured after 1 minute in boiling water (100° C. water bath).

TABLE 1
Example compositions and film properties

| | | | | | | | THF | Peel |
|---|---|---|---|---|---|---|---|---|
| | | | | Haze | Shrink | Shrink | seal | force |
| No. | Skin | Tie | Core | % | %, MD | %, TD | width | g/in |
| 1 | COC + 2% | COC + 2% | 80% VMX-3980 + | 15 | 4.6 | −55 | 3/8″ | 290 |
| | AMF702 | AMF702 | 20% EP-8573 | | | | | |
| 2 | COC | COC | 80% VMX-3980 + | 2 | 4.6 | −70 | 3/8″ | 468 |
| | | | 20% EP-8573 | | | | | |
| 3 | COC + 0.1% | COC + 0.1% | 80% VMX-3980 + | 1.5 | 7.3 | −67 | 3/8″ | 564 |
| | Irganox-1010 | Irganox-1010 | 20% EP-8573 | | | | | |
| 4 | COC + 1% | 60% EP-8573 + | 60% EP-8573 + | 1 | 0 | −37 | 3/8″ | 239 |
| | Be-Square 195 | 40% VMX- | 40% VMX-3980 | | | | | |
| | | 3980 | | | | | | |
| 5 | KR52 + | Kraton G1645 | 80% VMX-3980 + | 13 | 4.1 | −51 | 3/8″ | 307 |
| | EA3400 (50/50) | | 20% EP-8573 | | | | | |
| 6 | COC | Tuftec H1041 | 80% VMX-3980 + | 10 | 7 | −58 | 3/8″ | 1303 |
| | | | 20% EP-8573 | | | | | |
| 7 | COC + 0.1% | COC + 0.1% | 80% VMX-3980 + | 12 | — | — | 3/8″ | 649 |
| | Irganox-1010 | Irganox-1010 | 20% EP-8573 | | | | | |
| 8 | COC | COC | 80% VMX-3980 + | 12 | 0 | −59 | 1/4″ | 164 |
| | | | 20% EP-8573 | | | | | |
| 9 | DK11 | Chevron K | 80% VMX-3980 + | 2 | 0 | −54 | 1/4″ | 221 |
| | | resin DK11 | 20% EP-8573 | | | | | |
| 10 | KR52 + | Kraton G1645 | 80% VMX-3980 + | 13 | 4.1 | −51 | 1/4″ | 235 |
| | EA3400 (50/50) | | 20% EP-8573 | | | | | |
| 11 | HIPS-740 | Kraton G1645 | 80% VMX-3980 + | 70 | 0.9 | −43 | 1/4″ | 182 |
| | | | 20% EP-8573 | | | | | |
| 12 | COC- | Tuftec H1041 | 80% VMX-3980 + | 10 | 7 | −58 | 1/4″ | 443 |
| | 8007F400 | | 20% EP-8573 | | | | | |

It was found that tie layers comprising at least 70 wt % or 80 wt % or 90 wt % to 100 wt % of a styrenic block copolymer such as G1645 or H1041 had improved (increased) peel force, in particular, when H1041 was present in tie layers. Preferably, the peel force of the inventive films was at least 400 g/inch or 500 g/inch or 600 g/inch or 800 g/inch, with a TD shrinkage of at least 10% or 20% or 30% or 40%. The MD has no shrinkage and an expansion of less than 10% or 5%. The film in Sample 7 was the same composition as Sample 3, but made using a different film line and non-optimal conditions.

In particular, for Sample 7, when the film was produced on a separate film line, the MDO temperature was set slightly lower. This might cause micro fractures in the skins (COC as amorphous glassy polymer); that could produce higher haze. Another cause of the high haze could be due to reclaim material added back into the core layer. In production, reclaim material is often added into the core. The extruder on this separate line does not have ideal mixing capabilities. Thus, reclaimed COC likely did not get dispersed into finer particles. That would also give us higher haze compared to, for example, Sample 3.

Having described the various embodiments of the oriented multi-layered films, provided here are numbered embodiments describing certain features:

1. A multi-layer heat shrink (preferably, primarily in the TD) film comprising:

a) a core layer comprising at least,
(i) from 5 wt % or 10 wt % to 30 wt % or 40 wt % or 50 wt % of a polypropylene;
(ii) an α-olefin copolymer selected from at least one of propylene-based elastomers, ethylene plastomers, metallocene catalyzed linear low density polyethylenes, and blends thereof, the α-olefin copolymer having a melting point lower than the polypropylene;

b) at least one skin layer comprising a cyclic olefin copolymer (COC); and

c) at least one tie layer between at least one skin layer and the core layer, the tie layer comprising a material or blend of materials having a Hardness (ISO 7619, Type A) of from 45 or 50 or 55 or 60 to 90 or 95 or 100; and a Tensile Strength (ISO 37) of from 10 MPa or 15 MPa or 17 MPa or 19 MPa to 23 MPa or 25 MPa or 27 MPa or 30 MPa; and optionally an Elongation (ISO 37) of from 400% or 450% or 500% to 750% or 800% or 850% or 900%.

2. The film of numbered embodiment 1, wherein the tie layer comprises (or consists essentially of) a styrenic block copolymer.
3. The film of numbered embodiment 2, wherein the styrenic block copolymer comprises from 15 wt % or 20 wt % or 25 wt % to 35 wt % or 40 wt % or 45 wt % or 50 wt % styrenic derived units, by weight of the copolymer.
4. The film of numbered embodiment 2, wherein the styrenic block copolymer is a styrene-ethylene/butylene-styrene terpolymer having a melt flow rate (MFR, ASTM D 1238, 230° C. at 2.16 kg) of from 0.5 g/10 min or 1 g/10 min or 2 g/10 min or 3 g/10 min to 6 g/10 min or 8 g/10 min or 10 g/10 min or 12 g/10 min.
5. The film of any one of the previous numbered embodiments, comprising two skin layers, each of the skin layers comprising a cyclic olefin copolymer.
6. The film of any one of the previous numbered embodiments, wherein the α-olefin copolymer has a peak melting point in the range of from 60° C. to less than 125° C.
7. The film of any one of the previous numbered embodiments, wherein the polypropylene in the core comprises from 60 wt % or 70 wt % or 80 wt % or 85 wt % or 90 wt % or 95 wt % to 99 wt % to 100 wt % propylene-derived units and from 0 wt % or 1 wt % to 5 wt % or 10 wt % or 15 wt % or 20 wt % or 30 wt % or 40 wt % C₂ or C₄ to C₁₀ α-olefin derived units, and possessing a melting point (ASTM D3418) of at least 125° C. or 130° C. or 140° C. or 150° C. or 160° C.
8. The film of any one of the previous numbered embodiments, wherein the polypropylene in the core comprises from 70 wt % to 95 wt % propylene-derived units and has a melting point of at least 130° C.
9. The film of any one of the previous numbered embodiments, wherein the COC is selected from random copolymers of ethylene or propylene and a cyclic olefin comprising at least one of norbornene, norbornene derivatives, tetracyclododecene, and tetracyclododecene derivatives.
10. The film of any one of the previous numbered embodiments, wherein the α-olefin copolymer is one or more propylene-based elastomers having a melting point from less than 70° C. or 80° C. or 90° C. or 100° C. or 105° C.
11. The film of numbered embodiment 10, wherein the propylene-based elastomer comprises within the range of from 6 wt % to 12 wt % or 16 wt % or 20 wt % or 25 wt % C₂ or C₄ to C₁₀ α-olefin derived units.
12. The film of numbered embodiment 11, wherein the COC has a glass transition temperature of from 70° C. to 80° C.
13. The film of any one of the previous numbered embodiments, wherein each skin layer comprises at least 50 wt % of COC.
14. The film of any one of the previous numbered embodiments, consisting in a three-layer film monoaxially oriented in the transverse direction.
15. The film of any one of the previous numbered embodiments, wherein the two skin layers comprise at least 90 wt % of a COC having a glass transition temperature of from 70° C. to 80° C.; and two tie layers in between each skin layer and each side of the core layer, the tie layers comprising styrenic block copolymers.
16. The film of any one of the previous numbered embodiments, wherein the peel force of the inventive films was at least 400 g/inch or 500 g/inch or 600 g/inch or 800 g/inch.
17. The film of any one of the previous numbered embodiments, wherein the TD shrinkage of the films is at least 10% or 20% or 30% or 40%.
18. A label comprising a film according to any one of the previous numbered embodiments.
19. The label of numbered embodiment 18, wherein the shrink label is a sleeve label.
20. A method of forming a TD shrink label of any one of the previous numbered embodiments, the method comprising coextruding at least four or five layers of materials, each layer comprising:

a) a core layer including at least,
(i) from 5 wt % or 10 wt % to 30 wt % or 40 wt % or 50 wt % of a polypropylene, and
(ii) an α-olefin copolymer selected from at least one of propylene-based elastomers, ethylene plastomers, metallocene catalyzed linear low density polyethylenes, and blends thereof, the α-olefin copolymer having a melting point lower than the polypropylene;

b) at least one skin layer comprising a cyclic olefin copolymer (COC); and

c) at least one tie layer between at least one skin layer and the core layer, the tie layer comprising a material or blend of materials having a Hardness (ISO 7619, Type A) of from 45 or 50 or 55 or 60 to 90 or 95 or 100; a Tensile Strength (ISO 37) of from 10 MPa or 15 MPa or 17 MPa or 19 MPa to 23 MPa or 25 MPa or 27 MPa or 30 MPa; and optionally an Elongation (ISO 37) of from 400% or 450% or 500% to 750% or 800% or 850% or 900%;

forming an at least three, four, or five layer film therefrom;

stretching the film in the machine direction (MD) at a temperature that is within a range of from 4° C. below the T_{g} of the COC in the skin layer(s) to a temperature greater than or equal to the T_{g} of the COC in the skin layer(s) at a stretching ratio within the range of from 1.05 to 2.8, at a stretching time within the range of from 1 to 10 seconds; and

stretching in the transverse direction (TD) at a temperature within the range of from 70° C. to 120° C. at a stretching ratio within the range of from 4 to 10.

21. The method of numbered embodiment 20, wherein the peel force of the inventive films was at least 400 g/inch or 500 g/inch or 600 g/inch or 800 g/inch.
22. The method of any one of the numbered embodiments 20 and 21, wherein the TD shrinkage of the films is at least 10% or 20% or 30% or 40% after exposure to boiling water.
23. The method of any one of the numbered embodiments 20 to 22, wherein the upper range of the MDO temperature is no more than 5° C. or 10° C. or 15° C. above the T_{g} temperature.
24. The method of any one of the numbered embodiments 20 to 23, wherein the MDO temperature is set at a temperature within the range of from 70° C. to 90° C.
25. The method of any one of the numbered embodiments 20 to 24, wherein the tie layer comprises (or consists essentially of) a styrenic block copolymer.
26. The method of any one of the numbered embodiments 20 to 25, wherein the MDO and the TDO temperature is at least as high as the T_{g} of the polymeric component in the whole multi-layered film (any of the layers) with the highest T_{g}, but preferably no more than 5° C. or 10° C. or 15° C. above the T_{g} of the polymer with the highest T_{g} temperature, and no more than 5° C. below the polymer with the highest T_{g} in a particular embodiment.

In yet another embodiment is the use of a multi-layer heat shrink (preferably, primarily in the TD) film as a label, the film comprising a core layer comprising at least from 5 wt % or 10 wt % to 30 wt % or 40 wt % or 50 wt % of a polypropylene, and at least one α-olefin copolymer selected from the group consisting of propylene-based elastomers, ethylene plastomers, metallocene catalyzed linear low density polyethylenes, and blends thereof, the α-olefin copolymer having a melting point lower than the polypropylene; at least one skin layer comprising a cyclic olefin copolymer (COC); and at least one tie layer between at least one skin layer and the core layer, the tie layer comprising a material or blend of materials having a Hardness (ISO 7619, Type A) of from 45 or 50 or 55 or 60 to 90 or 95 or 100; and a Tensile Strength (ISO 37) of from 10 MPa or 15 MPa or 17 MPa or 19 MPa to 23 MPa or 25 MPa or 27 MPa or 30 MPa; and optionally an Elongation (ISO 37) of from 400% or 450% or 500% to 750% or 800% or 850% or 900%.

1. A multi-layer heat shrinkable film comprising:
a) a core layer comprising:
(i) from 5 wt % to 50 wt % of a polypropylene, and
(ii) an α-olefin copolymer selected from at least one of propylene-based elastomers, ethylene plastomers, metallocene catalyzed linear low density polyethylenes, and blends thereof, the α-olefin copolymer having a melting point lower than the polypropylene;
b) at least one skin layer comprising a cyclic olefin copolymer (COC); and
c) at least one tie layer between at least one skin layer and the core layer, the tie layer comprising a material or blend of materials having a Hardness (ISO 7619, Type A) of from 45 to 100; and a Tensile Strength (ISO 37) of from 10 MPa to 30 MPa.

2. The film of claim 1, wherein the tie layer comprises a styrenic block copolymer.

3. The film of claim 2, wherein the styrenic block copolymer comprises from 15 wt % to 50 wt % styrenic derived units, by weight of the copolymer.

4. The film of claim 2, wherein the styrenic block copolymer is a styrene-ethylene/butylene-styrene terpolymer having a melt flow rate (MFR, ASTM D 1238, 230° C. at 2.16 kg) of from 0.5 g/10 min to 12 g/10 min.

5. The film of claim 1, comprising two skin layers, each of the skin layers comprising a cyclic olefin copolymer.

6. The film of claim 1, wherein the α-olefin copolymer has a peak melting point in the range of from 60° C. to less than 125° C.

7. The film of claim 1, wherein the polypropylene in the core layer comprises from 60 wt % to 100 wt % propylene-derived units and from 0 wt % or 1 wt % to 40 wt % C₂ or C₄ to C₁₀ α-olefin derived units, and possessing a melting point (ASTM D3418) of at least 125° C.

8. The film of claim 1, wherein the polypropylene in the core layer comprises from 70 wt % to 95 wt % propylene-derived units and has a melting point of at least 130° C.

9. The film of claim 1, wherein the COC is selected from random copolymers of ethylene or propylene and a cyclic olefin comprising at least one of norbornene, norbornene derivatives, tetracyclododecene, and tetracyclododecene derivatives.

10. The film of claim 1, wherein the α-olefin copolymer is one or more propylene-based elastomers having a melting point from less than 105° C.

11. The film of claim 10, wherein the propylene-based elastomer comprises propylene and within the range of from 6 wt % to 25 wt % C₂ or C₄ to C₁₀ α-olefin derived units.

12. The film of claim 11, wherein the COC has a glass transition temperature of from 70° C. to 80° C.

13. The film of claim 1, wherein each skin layer comprises at least 50 wt % of COC.

14. The film of claim 1, comprising a three-layer film monoaxially oriented in the transverse direction.

15. The film of claim 5, wherein the two skin layers comprise at least 90 wt % of a COC having a glass transition temperature of from 70° C. to 80° C.; and further comprising a tie layer in between each skin layer and each side of the core layer, the tie layers comprising styrenic block copolymers.

16. The film of claim 1, wherein the peel force of the inventive films was at least 400 g/inch.

17. The film of claim 1, wherein the TD shrinkage of the film is at least 10%.

18. A label comprising a film according to claim 1.

19. The label of claim 18, wherein the shrink label is a sleeve label.

20. A method of forming a TD shrinkable film comprising coextruding at least three layers of material comprising:
a) a core layer including at least:
(i) from 5 wt % to 50 wt % of a polypropylene, and
(ii) an α-olefin copolymer selected from at least one of propylene-based elastomers, ethylene plastomers, metallocene catalyzed linear low density polyethylenes, and blends thereof, the α-olefin copolymer having a melting point lower than the polypropylene;
b) at least one skin layer comprising a cyclic olefin copolymer (COC); and
c) at least one tie layer between at least one skin layer and the core layer, the tie layer comprising a material or blend of materials having a Hardness (ISO 7619, Type A) of from 45 to 100; a Tensile Strength (ISO 37) of from 10 MPa to 30 MPa;
forming an at least a three-layer film therefrom;
stretching the film in the machine direction (MD) at a temperature that is within a range of from 4° C. below the T_{g} of the COC in the skin layer(s) to a temperature greater than or equal to the T_{g} of the COC in the skin layer(s) at a stretching ratio within the range of from 1.05 to 2.8, at a stretching time within the range of from 1 to 10 seconds; and
stretching in the transverse direction (TD) at a temperature within the range of from 70° C. to 120° C. at a stretching ratio within the range of from 4 to 10.

21. The method of claim 20, wherein the peel force of the film is at least 400 g/inch.

22. The method of claim 20, wherein the TD shrinkage of the films is at least 10% after exposure to boiling water.

23. The method of claim 20, wherein the upper range of the MDO temperature is no more than 15° C. above the T_{g} temperature.

24. The method of claim 20, wherein the MDO temperature, at a line speed of from 90 fps to 600 fps, is set at a temperature within the range of from 70° C. to 90° C.

25. The method of claim 20, wherein the tie layer comprises (or consists essentially of) a styrenic block copolymer.

26. The method of claim 20, further comprising forming a label from the film.
